(19) United States
(12) Patent Application Publication
(10) Pub. No.: US 2005/0166071 A1
(43) Pub. Date: Jul. 28, 2005

(54) Data network related arrangement (multilateral )

(76) Inventor: Erik Landberg, Stocksund (SE)

Correspondence Address: BURNS DOANE SWECKER & MATHIS L L P, POST OFFICE BOX 1404, ALEXANDRIA, VA, 22313-1404, US

(21) Appl. No.: 10/500,555

(22) PCT Filed: Nov. 21, 2002
(86) PCT No.: PCT/SE02/02120

(30) Foreign Application Priority Data
Dec. 21, 2001 (SE) 0104352-0

(51) Int. Cl. H04L 9/00

(52) U.S. Cl. 713/201

(57) ABSTRACT

The present invention concerns a data network related information-carrying and information-transferring arrangement, that includes a central unit (10) and a number of slave units (11, 15), which co-act with said central unit (10) via information-transmission (1), wherewith a document (D) can be sent to the central unit (10) from a chosen slave unit (11). The electronic document (D) includes protected text (d1) and at least one (d2) signature of a number of requisite signatures and can be sent to the central unit (10), wherein the central unit is adapted to check the document (D) automatically with regard to chosen aspects of the document. The central unit is also adapted to send the document (D), bearing the electronic signature, automatically to each of the remaining (15) parties that are required to sign the agreement document in order for the agreement to be binding. Each of these parties signs the document (D) electronically and returns it to the central unit (10), which thereafter initiates activation of the agreed measures via available means (24).

The arrangement enables a multi-lateral agreement to be reached between two or more parties (A, B), where chosen slave units (11, 15) are assigned to one party (A) and chosen slave units (13, 16) are assigned to the other party (B).

### FIELD OF THE INVENTION

The present invention relates to a data network related arrangement and more particularly to such an arrangement that provides an information-carrying and information-transferring facility between connected units and/or stations.

The inventive arrangement includes a central unit and a number of two-way information transfer units that can co-act with the central unit, said two-way units being referred to as slave units in the following text and can be designated “clients” in the case of certain transactions.

One information transfer mode, initialised by the central unit, which in certain transactions can be designated “session”, in respect of one or more of the slave units will normally be preceded by an authenticating handshake procedure established there between.

An information transfer mode, initialised by a selected slave unit, in respect of said central unit shall necessarily be preceded by an authenticating handshake procedure established there between.

A document can be sent from a slave unit to the central unit and vice versa, subsequent to having established an accepted information transfer via said authenticating handshake procedure.

The present invention finds particular use with regard to exchanging documents between one or more chosen slave units and the central unit, or vice versa, where the document bears or can be provided with an electronic signature related to said slave unit.

By the expression “electronic signature” is meant in the following description that a person, authorised to sign such a document, signs electronically a transmitted electronic document and returns said document duly signed.

The present invention is primarily based on the establishment of a multilateral session, established between two or more parties while using an intermediary central unit.

### DESCRIPTION OF THE PRIOR ART

It is earlier known a number of mutually different data network related information-carrying and information-transferring systems to create an arrangement that includes a central unit and a number of slave units, which can each co-act with the central unit, via the transfer of information over the data network.

It is also known to allow such an arrangement to create conditions which enable the central unit to initiate an information transfer mode or session in respect of one or more of said slave units, and vice versa.

This information transfer can then be preceded by an authenticating handshake procedure established there between, so as to create thereby conditions, which enable document-related information to be transferred in an accepted and secure fashion.

With regard to significant features of the present invention, it can also be mentioned that there are also known to the art different systems and arrangements that allow electronic documents, signed electronically by an authorised signatory of the company, to be sent to a central unit, or to a receiving slave unit via said central unit, where a thus applied signature can be considered as an original signature by virtue of the authenticating handshake procedure.

With regard to embodiments and applications proposed, in accordance with the present invention, it can be mentioned that there are known to the art different arrangements that enable economic transactions to be performed, by enabling one or more slave units or clients to be connected over an established data network with an economic transaction intermediary central unit, for example a banking system or the like.

In the case of this latter application, there are known to the art different processes for protecting the text of a document and to securely establish a session via an information transfer between a client and a bank, such as to enable an economic transaction to be carried out without the client needing to be present physically in the bank premises.

### SUMMARY OF THE PRESENT INVENTION

Technical Problems

When taking into consideration the technical deliberations that a person skilled in this particular art must make in order to provide a solution to one or more technical problems that he/she encounters, it will be seen that on the one hand it is necessary initially to realise the measures and/or the sequence of measures that must be undertaken to this end, and on the other hand to realise which means is/are required to solve one or more of said problems. On this basis, it will be evident that the technical problems listed below are highly relevant to the development of the present invention.

When considering the prior art as described above, it will be seen that a technical problem resides in the ability to create and to configure a data network related arrangement that has a multilateral application, where an electronic document can be transferred from one or more slave units to a central unit or vice versa, where said document requires an authorised signature from each of a number of authorised signatories, each associated with his/her own part of an agreement, and where said document may also include one or more electronic signatures during the interchange phase between said two parties, while monitoring the interchange phases with the aid of said central unit.

It will also be seen that a technical problem resides in creating a functional arrangement which will enable an agreement or contract to be signed or an electronic legal transaction or legal document to be signed electronically by all involved parties more efficiently, without requiring all persons involved to gather at one and the same place when said persons are known or are able to identify themselves.

It will also be seen that a technical problem resides, to this end, in providing an arrangement, which can be followed synchronously by the central unit but which can be carried out sequentially and asynchronously without requiring the parties involved in the agreement to gather together at the same time and in the same place.

Another technical problem resides in the ability to realise the significance of and the advantages afforded by using in this regard an electronic document that is provided with a text-protected agreement text and/or text-protected signature or signatures and the requirement of one or more necessary further signatures, and to send this document to the central unit from a first slave unit and from a party to the agreement.

Another technical problem resides in the ability to realise the significance of and the advantages afforded by adapting the central unit to check the document automatically in respect of chosen and applicable features.

Another technical problem resides in the ability to realise the significance of and the advantages afforded by allowing said check to include at least one of the following features: a check to ascertain that the text of the agreement document is protected; a check to ascertain that one or more of the accompanying signatures consists/consist of one or more requisite electronic signatures; and a check to ascertain what other electronic signatures are required in order for the multilateral agreement to be valid and legally binding.

It will also be seen that a technical problem resides in the ability to realise the significance of and the advantages afforded by adapting said central unit to send said received electronic document, bearing one or more electronic signatures, automatically to each of the remaining parties required to sign the document or the agreement electronically, in order to make the agreement binding between two or more parties.

Another technical problem resides in the ability to realise the significance of and the advantages afforded by allowing each of these remaining parties to sign the document electronically and then to return the document to the central unit, which then checks the contents of the document, such as the text of the agreement, whether or not the text is still protected, and that the accompanying electronic signatures consist of authorised signatures from all parties to the agreement.

Another technical problem resides in the ability to realise the significance of and the advantages afforded by causing the central unit to activate automatically available means, for initiating and carrying out the conditions established and chosen in the document and/or the text of the agreement, when the document and/or the agreement has been signed by all authorised parties and duly checked.

Still another technical problem resides in the ability to create conditions in respect of the central unit such that it can be determined that the person or persons who has/have signed a document on behalf of one or all agreement parties is truly authorised to sign the document in question.

In the case of an arrangement of the kind concerned here, when such a document shall be signed by a number of authorised persons in respect of a part of a multilateral agreement, a technical problem resides in the ability to realise the significance of and the advantages afforded by creating conditions which enable the central unit to establish readily and automatically which persons are authorised and to allow each of said persons to send the document concerned electronically and thereafter obtain the document in return duly signed by each of the authorised persons within a given time frame.

Another technical problem is one of being able to realise the significance of and the advantages afforded by allowing said document to contain or to have added thereto information concerning those persons who have the required authority to sign the document on behalf of one party and are in amicable accord with a document-carried and text-protected instruction or agreement sent to the central unit.

Another technical problem resides in the ability to realise the significance of and the advantages afforded by allowing the central unit to include first means, for checking whether or not authority-related information given for all parties to the agreement is correct, according to a register accessible to the central unit.

A further technical problem resides in the ability to realise the significance of and the advantages afforded by providing the central unit with second means which, when said information is correct, can be initialised and activated such as to allow the central unit to carry out the measures stated in the incoming and duly signed document in accordance with issued instructions or agreements.

The present invention finds particular application when the central unit consists of or is related to a banking institution or like operator and where said instructions shall be related to an economic transaction and/or to another transaction which is of the utmost importance to the parties in general.

Another technical problem is allied with allowing said instruction to the central unit to be related to an agreement between two or more parties each having a slave unit set-up, and where the central unit primarily serves as a mediator/data exchange.

Another technical problem resides in the ability to realise the significance of and the advantages afforded by creating conditions that enable the central unit to include or to co-act with third means, functioning automatically to copy said document and its protected agreement text with instructions or agreements and one or more electronic signatures from a first party on the one hand, and to send such a copy automatically to each person who shall sign the document concerned electronically in their authoritative capacity in respect of the first party and/or a second party or further parties, on the other hand.

Another technical problem resides in the ability to realise the significance of and the advantages afforded by enabling the central unit to send automatically to each person who shall sign the document electronically in their authoritative capacity in respect of a second party in the document and the agreement, when each person associated with a first party in his authoritative capacity has sent electronically to the central unit his copy of the document containing instructions or agreements and duly signed electronically.

A technical problem also resides in realising the significance of and the advantages afforded by allowing the central unit to include or to co-act with fourth means, that functions to assist in carrying out necessary authority checks in an archive or filing department for relevant powers of attorney concerning all parties to the agreement.

A technical problem also resides in the ability to realise the significance of and the advantages afforded by allowing said archive to include a number of organisation identities, such as organisation numbers, current e-mail addresses, legal domiciles, registered offices, seats, certificates relating to private keys, and the like pertaining to all parties to the agreement.

Another technical problem resides in the ability to realise the significance of and the advantages afforded by allowing the central unit to co-act with or to include fifth means, adapted for the registration of powers of attorney, where possibilities exist to change stored information for all or chosen parties to the agreement, such as the duration of a power of attorney, activation of blocking functions and/or the insertion of new information, where said new information can either be entered via the central unit or via a relevant slave unit.

Another technical problem resides in the ability to realise the significance of and the advantages associated with allowing such a power-of-attorney register to include a number of authority codes related to all or selected parties to the agreement.

Another technical problem resides in the ability to realise the significance of allowing said authority codes to be structured to establish those connections tied to a chosen document with a chosen instruction or a chosen agreement.

In addition, the present invention allows a first authority code to denote that the authority required is the signatures of the entire board, that a second authority code denotes that the authority required is two or more given persons in combination, a third authority code denotes that the authority required is the signature of the Managing Director (current matters, usual routines), a fourth authority code denotes that the authority required is a message to a member of the Board of Directors, such as the Chairman of the Board, and a fifth authority code denotes that the authority required is a financial power of attorney.

Solution

The present invention thus relates to an earlier known data network related, information-carrying and information-transferring arrangement, which includes at least one central unit and at least a number of slave units that can co-act with the central unit via information transfer, and where an information-transfer mode initialised by the central unit in respect of one or more of said slave units can be preceded by an authenticating handshake procedure established there between, whereas an information transfer mode initialised by a chosen slave unit with respect to said central unit is to be preceded by an authenticating handshake procedure established there between, whereafter an electronic document can be sent from a chosen slave unit to the central unit, or vice versa.

With the intention of solving one or more of the aforesaid technical problems, it is proposed, in accordance with the invention, that an electronic document concerning a multilateral agreement and provided with protected text and at least one of a number of requisite electronic signatures in respect of a first party can be sent to the central unit, said central unit being adapted to check the document automatically with regard to selected and applicable features.

The check shall consist of at least one of the following features: a check to ascertain whether or not the text of the agreement document is protected; a check to ascertain whether or not an accompanying signature or signatures consists/consist of at least one of a number of requisite electronic signatures; and a check to ascertain which other electronic signatures are required in respect of the parties to the agreement in order for the agreement to be binding.

The central unit is also adapted to send said document automatically, bearing at least one electronic signature from one party, to each of the remaining parties that need to sign the agreement text in order for the multilateral agreement to be binding.

Each of these remaining parties sign the document electronically and return it electronically to the central unit, which checks whether or not the text of the agreement document is still protected and that accompanying signatures have been signed by authorised and relevant parties to the agreement.

When the agreement text has duly been signed by all authorised parties, the central unit automatically activates means for initiating the conditions established and chosen in the text of the agreement.

By way of suggested embodiments, that lie within the scope of the present invention, it is proposed that the document shall contain or have attached (married) thereto information concerning the person or persons to which requisite authority has been assigned to endorse and electronically sign said document so that said document will be legally binding to the benefit of a party to the agreement, said document sent to the central unit carrying one or more instructions and/or one or more agreements.

In this regard, it is proposed that the central unit will include first means, for checking in a register accessible to the central unit whether or not determined and/or delivered authority-related information is correct or not.

If the information is incorrect, the slave unit concerned is informed of the situation.

If the information is correct, the central unit will cause the activation of second means, which can be initialised to allow the central unit to carry out the measures given in the incoming document, in accordance with the instructions or agreements entered on the document.

By way of suggested embodiments, that lie within the scope of the inventive concept, it is proposed that said instruction to the central unit, a banking unit, telecom company or the like, may be related to an economic transaction agreed between two or more parties.

According to the invention, the instruction to the central unit may be related to an agreement between two chosen parties, who each have his/her own slave unit, where the central unit shall function as an intermediary.

It is also proposed that the central unit shall include or co-act with third means, which functions to allow the document with its instructions or agreements to be copied on the one hand, and to send such a copy to each person who shall electronically sign the document in his/her capacity of an authority with respect to a first party in an agreement.

It is also proposed that when each of said persons has returned his/her copy of the duly electronically signed document in his/her authoritative capacity, in a reliable fashion, the central unit will function to send automatically a copy of the thus signed document to each one of a second party in the agreement who shall electronically sign the document in his/her authoritative capacity.

It is also proposed in accordance with the invention that the central unit will include or co-act with fourth means, for carrying out requisite authority checks in an archive containing relevant powers of attorney.

The archive shall include a number of organisation identities, and it is proposed, in accordance with the invention, that these identities will include organisation numbers, current e-mail addresses, company seats, certificates concerning private keys, or the like.

The present invention also enables the central unit to co-act with or to include fifth means, for registering powers of attorney related to all parties to the agreement, where the possibility exists of changing stored information, such as the duration of an appointment, activation of a blocking function and/or the addition of new information.

More particularly, it is proposed, in accordance with the invention, that a number of authority codes applicable to all agreement parties can be entered into the power-of-attorney register.

These qualification codes or authority codes shall be structured so that they can determine conditions that are tied to a chosen instruction and/or a chosen agreement.

It is proposed in particular that;
a first authority code shall denote, in order for the document to be valid, that it must be signed by the entire Board;
a second authority code shall denote that the document must be signed by two or more given persons in order to be valid;
a third authority code shall denote that the document shall be signed by the Managing Director (standard issues) in order to be valid;
a fourth authority code shall denote that the document must be signed by a member of the Board, such as the Chairman, in order to be valid; and
a fifth authority code shall denote that the required authority is a so-called financial power of attorney.
   Advantages

Those advantages primarily significant to a data network related, information-carrying and information-transferring, arrangement reside in the provision of conditions that enable a central unit to carry out instructions and/or agreements obtained through the medium of an electronic document compiled in one or more slave units, while retaining a secure authenticating handshake procedure, and where the central unit can readily check electronically which persons are authorised to sign the document concerned electronically, relating to a current document carrying instructions or agreements applicable to all parties to the agreement.

In accordance with the invention, the central unit is able to determine and/or to check whether or not determined and/or supplied authority information is correct or not, via an available register, wherewith the central unit is able to take the responsibility of sending a document containing chosen instructions or agreements to each of the authorised parties participating in the agreement, and also to receive from each of said authorised parties electronically composed signatures, all during the establishment of an authenticating handshake procedure.

This provides a functional arrangement which enables the signing of agreement documents or other legal documents concerning multilateral agreements to be effected more efficiently, with a central unit acting as an intermediary and without the persons concerned needing to gather in one and the same place where they are known or can identify themselves.

The invention provides a virtual gathering space and enables an asynchronous session to be carried out.

The primary characteristic features of an inventive data network related and information-carrying and information-transferring arrangement are set forth in the characterising clause of the accompanying Claim 1.

### BRIEF DESCRIPTION OF THE DRAWINGS

A data network related, information-carrying and information-transferring, arrangement, at present preferred, comprising a central unit and a number of slave units, that are able to co-act with said central unit via information transmission and that each forms parties within a two-parties included agreement, will now be described in more detail by way of example with reference to the accompanying drawings, in which;

FIG. 1 is a greatly simplified overview of the data network related arrangement, that includes a central unit and a few slave units, which all are able to co-act with the central unit and which are co-ordinated to represent two different parties related to an agreement;

FIG. 2 is a block diagram illustrating different means and functions assigned to the central unit, which acts as an intermediary in an information transfer mode from and to one of said slave units; and

FIG. 3 is a simplified function diagram illustrating the co-action between said central unit and a number of slave units in the interchange of a document that needs to be signed by an authorised representative of each agreement party.

### DESCRIPTION OF EMBODIMENTS AT PRESENT PREFERRED

It is pointed out initially that we have chosen to use, in the following description of embodiments at present preferred and including significant characterristic features of the invention and illustrated further in the figures of the accompanying drawings, special terms and terminology with the intention of illustrating the inventive concept more clearly.

However, it will be noted that the expressions chosen here shall not be seen as limited solely to the chosen terms used in the description, but that each term chosen shall be interpreted as also including all technical equivalents that function in the same or at least essentially the same way so as to achieve the same or essentially the same intention and/or technical effect.

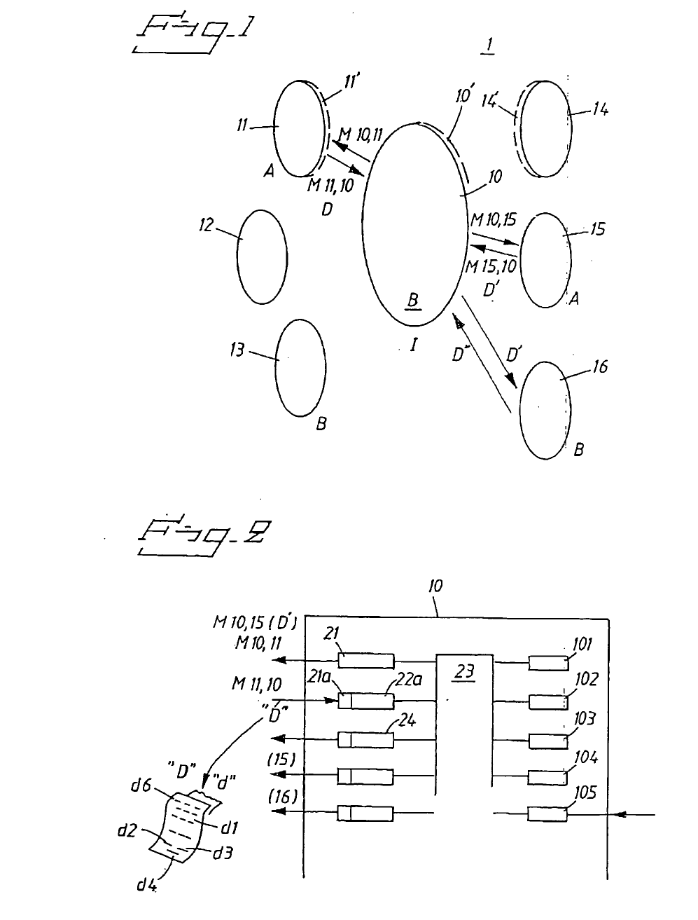

FIG. 1 is a greatly simplified illustration of a data network related, information-carrying and information-transferring arrangement 1. The arrangement includes a central unit 10 and a number of slave units 11, 12, 13, 14, 15 and 16, which are able to co-act with the central unit. The slave units 11, 15 are assigned to a first party “A”, whereas the slave units 13, 15 are assigned to a second party “B”, both of said parties being included in an information transfer with the central unit 10 as an intermediary and a control unit in connection with a multilateral agreement.

The invention is primarily concerned with an application established between two parties, a first party “A” and a second party “B” in a multilateral session. It will be understood, however, that the multilateral session may also engage other parties.

This information transfer can be achieved with the aid of each of said slave units, via an information-carrying and information-transferring system “I”.

The data network system “Internet” may well be used in the arrangement illustrated in FIG. 1, said “Internet”-system being referenced “I” in FIG. 1.

The person skilled in this particular field is well aware of the information carrying or transfer sequences and information transfer modes or sessions that can be established between the central unit and one or more of the slave units 11 to 16 and how similar information carrying connections can be achieved between one or more of the slave units 11 to 16 and the central unit 10.

It will also be obvious to a person skilled in this technical field that the illustrated central unit 10 may exist as a plurality of different units, this being illustrated schematically in FIG. 1 by the reference sign or numeral 10′.

Correspondingly, a plurality of slave units, such as those referenced 11′ and 14′ can, of course, co-act with said central unit 10 or the additional central unit 10′.

It will also be obvious to one skilled in this particular art that rules and protocol are required for the signal transmission of an electronic document containing one or more instructions and/or one or more agreement clauses. However, for the sake of clarity, such rules and protocols have not been described in this document.

It is mentioned, however, that at least when a document related to an economic arrangement and transactions shall be sent by the central unit, say the central unit 10, the unit is required to initiate an information transfer mode or session to one or more relevant slave units or clients and one or more parties included in the multilateral agreement, such initiation being preceded by a handshake procedure.

A number of such handshake procedures are known to the art and will not therefore be described in detail.

More specifically, each information transfer mode shall be preceded by an authenticating handshake procedure established between relevant parties.

An information transfer mode initialised in respect of the central unit 10 by a chosen slave unit, such as the slave unit 11, shall be preceded by an authenticating handshake procedure established there between.

An electronic “document” can then be sent from the slave unit 11 to the central unit 10.

A “document”, according to the present invention, may conveniently consist of one or more instructions, sent from a slave unit 11 to a central unit 10, to enable the central unit 10 to execute the given instructions and report the measures carried out back to the slave unit.

A “document”, according to the present invention, may also consist of an agreement that requires a commitment between two or more slave units, belonging to a first party “A”, such as slave units 11 and 15, wherein the central unit 10 shall be included as an intermediary and/or as a guarantor in respect of an economic transaction.

A number of slave units, such as 11, 15, may be associated with a first party “A” and a second number of slave units 13, 16 may be associated with a second party “B”, in respect of an agreement or contract.

FIG. 1 illustrates an information transfer mode, referenced M10, 11, between the central unit 10 and the slave unit 11, and an information transfer mode, referenced M11, 10, between the slave unit 11 and the central unit 10.

Also shown is an information transfer mode, referenced M10, 15, between the central unit 10 and the slave unit 15, and an information transfer mode, referenced M15, 10, from the slave unit 15 to the central unit 10.

As will be understood, each information transfer mode that shall be established between the central unit 10 and one or more slave units 13, 16, and vice versa, can be identified by reference signs based on the afore described structure.

The features of the invention will now be described in more detail with reference to an electronic “document”, with which two authorised electronic signatures are required of a first party “A”, in order for the document to be legally accepted, wherewith the signed document is sent from the slave unit 11 to the central unit 10.

The document “D” may contain, inter alia, instructions to the central unit 10 and an agreement, applicable between at least two parties “A” and “B”.

In order for the unit 10 to be able to carry out its task, it is assumed that the unit 10 requires two authoritative electronic signatures from two different persons of which each has a slave unit and is authorised by a first party “A”.

Should electronic signatures be required from more than two different persons, in respect of the first party “A”, the procedure associated with these conditions will be obvious.

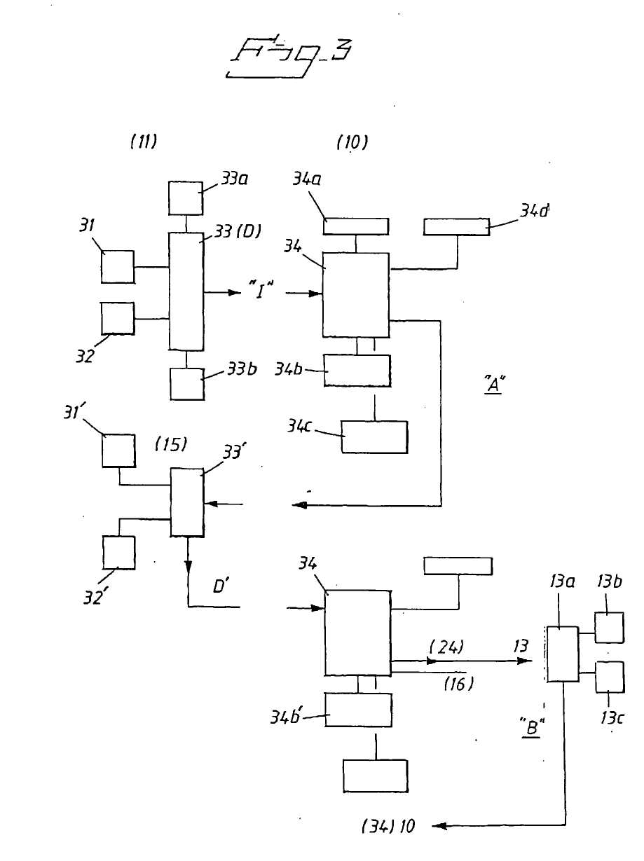

It is assumed that the document “D”, shown in FIG. 2, includes an agreement text “d1” and a single electronic signature “d2” when received by the unit 10 from the slave unit 11.

The unit 10 checks, inter alia, the electronic signature “d2” and when it is found to be correct causes the document to be copied, together with the signature, and sends the document to a selected second slave unit 15 for an electronic signature “d3” from an authorised person, belonging to the first party “A”, whose signature is missing from the document, where after the electronically signed document (D′) (d1, d2, d3) is returned to the central unit 10 (M15, 10), which then performs further requisite instructions subsequent to having made an automatic check.

FIG. 2 is a principle diagram illustrating the central unit 10.

An information transfer mode or session, referenced M10, 11 (M10, 15) initialised by the central unit 10 in respect of one or more of said slave units, such as the unit 11 (15), may be preceded by an authenticating handshake procedure established there between and relating to the party “A”, illustrated as a function block 21 in FIG. 2.

An information transfer mode or session initialised by a chosen slave unit 11 (15) in respect of said central unit 10, referenced (M11, 10 (M15, 10) shall be preceded by an authenticating handshake procedure established there between, this procedure being illustrated as a function block 21a.

Corresponding functions in the slave unit 11 (15), now shown in FIG. 2 with reference signs 21, 21a, have not been drawn or shown in the drawing.

A document “D”, including instructions in accordance with the above, is now sent from the slave unit 11 to the central unit 10 and received in a receiving circuit 22a and linked therefrom to a central processor unit 23.

The central unit 10 co-acts with the first means 101, with the aid of the central processor 23, to determine and/or check in a register available to the central unit whether or not the determined and/or stated authority information is correct in respect of party “A”, in respect of party “B” and in respect of other parties if so required.

In this regard, it can be conceived that the document “D” carries information “d6” concerning those persons that are authorised to sign in respect of party “A” and in respect of party “B”, this check being carried out in the unit 10 and in the means 101.

It is also conceivable that the document “D” includes an extract from a current registration document.

It is also conceivable to store in the means 101 a list of persons that are authorised to sign, on behalf of the company, with respect to specific assignments or commissions for both party “A” and party “B”.

It is assumed that the check carried out in means 101 is positive, wherewith the central processor 23 is caused to co-act with a second means 102 so as to allow the central unit 10 to carry out the steps and measures given on the incoming document (D) in accordance with stated instructions or agreements.

The document “D” can be sent to a slave unit 15 for signing, and returned as a document (D′) to the central unit 10.

The measures taken can be initialised with the aid of a circuit 24.

The document “D” will preferably include or have added thereto one or more pieces of information concerning those persons who have the requisite authority to endorse the instructions or the agreements stated on the document sent to the central unit 10.

Thus, in the case of this application, the document “D” includes protected agreement text and/or instructions “d1” and places “d2”, “d3” and “d4” where the document shall be signed electronically by authorised persons, where “d2” and “d3” are intended in respect of a first party “A” whereas the blank place or box “d4” is intended for the signature of a second party “B”.

The document “D” thus includes information concerning those persons that are authorised to sign the document that bears the instructions or the agreement “d1”. Alternatively, there can be added to the document “d1” a further document “d” which bears electronic information relating to those persons that have the necessary authority to sign the document bearing said instructions or agreements. By way of a further alternative, this information may be stored in the central unit 10 and related to the parties concerned.

In this particular case, the central unit 10 may comprise a bank or some other economic, financial institution and the instructions “d1” sent to the central unit 10 may be related solely to an economic transaction between two parties “A” and “B”, with the central unit 10 acting as an intermediary and the finalizer of the transaction.

The document “D”, sent to the central unit 10 and bearing said instructions, is primarily related to the central unit that shall carry out the measures required.

This central unit 10 shall thus carry out such measures as obtaining signatures from all persons concerned, carrying out the economic transaction and therewith ensure that one account number is billed while another account number is credited a corresponding sum, wherewith the central unit 10 charges a fee for carrying out the economic transaction.

It is assumed that the person sending the document “D” to the central unit 10 is authorised and that he/she can sign his/her name electronically at “d2”.

The unit 10 copies the document “D” signed at “d2”, and sends the copy electronically to the e-mail address applicable to the person who shall sign the document electronically at “d3” and who belongs to the party “A”.

If the document requires the signature of another person belonging to the party “A”, such as at “d4”, the document is sent to this person via the output circuit 24.

Immediately the central unit 10 receives the document duly signed at “d2” and “d2” in respect of the one party “A” and at “d4” in respect of the second party “B”, the commission can be carried out and finalised subsequent to required checks having been made.

In this particular case, the instruction to the central unit 10 is related to an “agreement” between two parties “A” and “B”, where one party “A” is assigned the slave units 11, 15 and the second party “B” is assigned the slave units 13, 16, wherein each shall sign at “d4”.

Such an embodiment, in which an agreement shall be valid between two groups of slave units 11, 15 and 13, 16 respectively, and the central unit 10 shall function as an active or inactive intermediary, there is required in the central unit 10 a function system that can be described schematically in the following way.

The document “D” passes to the central process 23 in the same way as that earlier described.

The central processor 23 now co-acts with a third means 103, which is instrumental in copying the document “D” containing agreements “d1” and signatures

The central processor 23 can now create conditions which enable such a copy D′ to be sent electronically to each person who is authorised to sign the document electronically on behalf of his/her respective party “A” and “B”, wherewith each of said persons returns the document to the unit 10 within a given time period and the unit 10 carries out the commission subsequent to checks having been carried out.

In the case of the FIG. 2 embodiment, a copy (D) (d1, d2) is sent to the slave unit 15 for signing and its return to the unit 10, with the aid of an authenticating handshake procedure, wherewith the unit 10 copies the document (D′) (d1, d2, d3) received and sends said document to the slave unit 13 and/or 16 for signing by the party “B”.

It is thus assumed that the document “D” sent to the central processor 23 has been signed by an authorised person at “d2” on behalf of a first party, and that the document requires a further electronic signature “d3” from the first party “A”, where it is assumed that the signature “d3” shall be obtained from the slave unit 15, whereas an electronic signature “d4” belonging to the second party “B” shall be obtained via the slave unit 13 and/or 16.

The central processor 23 deals with copying of the document “D” that has first been sent from the slave unit 11 to the unit 10, and sends a copy to the slave unit 15.

When the slave unit 15 has electronically signed the document, the document is returned to the central processor 23, which, in a further sequence, sends the document (D′) bearing the signatures of the two authorised persons “d2” and “d3” respectively to the second party “B” for signing at “d4” or for further signatures.

When each responsible person of the first party “A” has duly signed the document carrying said instructions or agreements and has sent the document to the central unit 10, the central unit 10 thus sends a copy of the thus completed, signed document bearing said instructions or agreements through the medium of the central processor to each one of the second party “B” required to sign the document in their capacity of an authorised signatory, said copies being sent to each person simultaneously or in succession.

The central unit 10 that includes the central processor 23 also includes fourth means 104, functioning to carry out requisite authority checks.

This fourth means has the form of an archive 104, which is able to include a number of different organisation identities, such as organisation numbers, current e-mail addresses, company seats, certificates relating to private keys required to sign presented documents electronically.

The central unit 10, which includes the central processor 23, co-acts with or includes fifth means 105, for registering powers of attorney, where it is possible to alter stored information, such as the duration of a term of appointment, the activation of blocking functions and/or the insertion of new data, as illustrated with an arrow in FIG. 2.

A number of authority codes are included in the register 105.

These authority codes are structured and party-sorted so that conditions tied to a chosen instruction or to a chosen agreement based on a received document can be determined.

In this regard, it is proposed;
that a first authority code denotes that the required authority consists in the entire Board members signing the electronic document “D”;
that a second authority code denotes that the authority required consists of two or more name given persons in combination;
that a third authority code denotes that the authority required exists solely in the signature of the Managing Director (routine business matters);
that a fourth authority code denotes that the authority required exists in a message being sent to a chosen board member, such as a document sent to the Chairman of the Board electronically; and
that a fifth authority code requires the presentation of a so-called financial power of attorney.

More generally, the set-up and the use of the arrangement can be generally described as allowing a person, represented by the slave unit 11, to open a case with the aid of his/her PIN code.

The case obtains the form of a document “D” and is allotted an identity.

The text “d1” is then entered into the document “D”, i.e. information or agreement terms can be entered in the document.

Such a text can be protected against alterations (or text protected) with the aid of an electronic seal.

Those persons in party “A” and in party “B” required to sign the document (d2, d3 and (d4) respectively) in order for the document to be valid and legally binding are then noted, and a critical time frame, such as a date, within which the document shall be signed by all relevant persons, may be included therein.

The central unit 10 and the central unit processor 23 shall ensure that the “signature” and/or “signatures” from persons represented by relevant slave units 11, 15, 13, 16 are in place, and that all other persons, who shall sign the document electronically, have also signed said document and returned it to the central unit 10.

The present invention provides the possibility of liberating the signatories concerned from time and space (room) in respect of signing the document, since said parties are allowed to sign the document electronically in virtual space.

It will thus be obvious that the persons, represented by said slave units 11, 15; 13, 16, can take part in agreement processes and sign and determine the validity of the document electronically, regardless of the geographical positions of individual slave units.

The process is able to follow the electronic signatures of the remaining authorised persons asynchronously during the actual agreement process, via the central unit 10 and primarily the central processor 23, wherewith the agreement process can be completed sequentially and asynchronously.

Any updating of the power-of-attorney register and any possible power-of-attorney archive is effected in real time.

The invention also offers an advanced checking pattern for distribution of the cases in different stages, wherewith termination between the parties, i.e. between selected slave units and the central unit respectively, can be effected via open networks or closed networks, via encryption in the most suitable case.

FIG. 3 is a simplified schematic illustration of a function schedule for co-action between the central unit 10 and a number of slave units 11, 15, when exchanging a document between a first party “A” and a second party “B” with the central unit 10 acting as an intermediary.

More particularly, a block 31 indicates the presence of a company certificate, and a block 32 indicates the presence of a private key, available to an authorised person belonging to the one party “A”.

Reference numeral 33 is intended to illustrate the structure of a compiled document “D” that includes agreement text (d1) and a signature (d2), the text of said agreement being protected via a block 33a.

Block 33b is intended to show that other information, such as information intended directly for the central unit 34 (10), can be entered into the document “D”.

Such information may include a list of persons who shall sign the document, together with their electronic addresses; any symmetry in the sequence in which the document shall be signed; a time plan with respect to signing of the document.

The central unit 34 co-acts with a block 34a representing current “business rules” for current businesses, assignments or tasks.

Block 34b represents checking surfaces adapted, inter alia, to check the receipt of company certificate 31, used private key 32, relevant text protection 33a, public keys, time plans, etc.

Block 34c represents an authority register which either checks that information given on the document “D” is correct and that the document is signed by authorised signatories, in accordance with the structure of the document.

Block 34d represents a sequence of authorised signatories and/or a list of the signatories required in accordance with the measures concerned.

When the check has been carried out and the correct authority with regard to the one party “A” has been chosen, the document “D” bearing the signature “d2” and produced via the blocks 31, 32 is copied and sent to the slave unit 15 and the person concerned represented electronically by the block 33′.

This person signs the document via the company certificate 31′ and his/her private key 32′. The signed document (D′) is returned to the central unit 34, which checks the document in control circuits 34b′ at least with regard to
a. the correct authority with regard to all persons that have signed the document on behalf of party “A”;
b. the correct sequence when this criterion is required;
c. the correct electronic signature/signatures;
d. the correct time schedule; and
e. the correct text protection and a check to ensure that this protection has not been broken.

When these criteria have been fulfilled, the central unit 34 automatically initialises copying of the document (D′), which is now sent simultaneously to all slave units 13, 16 that shall sign the document on behalf of the second party “B”, or is sent to said slave unit 13, 16 in sequence.

FIG. 3 shows that the document (D′) is sent to the slave unit 13, which receives the document in a circuit 13a and signs the document at “d4” via a company certificate 13b and a private key 13c, and thereafter send the document (D″) to the central unit 10.

As soon as the check carried out by the central unit 10 shows that the signatures are correct, means (24) is activated to put the agreement “d1” into practice.

The means 24 can be initialised to finalise the conditions determined and selected in the text of the agreement.

It will be understood that the invention is not restricted to the afore described and illustrated exemplifying embodiment thereof, and that modifications can be made within the scope of the inventive concept as illustrated in the accompanying Claims.

1. A data network related information-carrying and information-transferring arrangement, comprising a central unit and a number of slave units that can co-act with a central unit via information transmission, wherein an information transfer mode or session, initialised by the central unit in respect of one or more of said slave units, can be preceded by an authenticating handshake procedure established there between, wherein an information transfer mode or session initialised by a chosen slave unit in respect of said central unit shall be preceded by an authenticating handshake procedure established there between, where after an electronic document can be sent from a chosen slave unit to the central unit, wherein the electronic document applicable to a multilateral agreement and provided with protected text and bearing at least one signature of a number of requisite signatures in respect of a first party can be sent to the central unit, wherein the central unit is adapted to automatically check the document in respect of chosen features; wherein said check comprises at least a check to ascertain that the text of the document is protected, a check to ascertain that the electronic signature (signatures) accompanying the document consist of one or more requisite electronic signatures related to one party, and a check to ascertain which other electronic signatures are required with respect to a second party in order for the agreement to be valid; in that said central unit is adapted to send said document bearing said electronic signature automatically to each of the remaining entities required to sign the agreement text in order for the agreement to be binding; in that each of said entities signs the document electronically and returns said document to the central unit, which checks that the text of the document is protected and that the accompanying signatures have been made by authorised persons from both or all parties; and in that, when the text has been signed by all authorised entities, the central unit automatically activates means for initiating conditions set and chosen in the text.

2. An arrangement according to claim 1, wherein the document contains or has added thereto information relating to the person or persons that has/have been given the necessary authority by participating parties to endorse and electronically sign said document, and a requisite sequential order.

3. An arrangement according to claim 1, wherein said document contains one or more instructions and/or one or more agreements.

4. An arrangement according to claim 1, wherein the central unit includes first means, for establishing and/or checking whether or not the authority-related information from both or all parties is correct, with the aid of a register accessible to the central unit, wherein, if the authority-related information is correct, the central unit uses second means, that can be activated to enable the central unit to carry out the measures given in the incoming document, in accordance with the instructions or agreements given in said document.

5. An arrangement according to claim 1, wherein the document has added thereto information relating to those persons that have the necessary authority to sign the document on behalf of a party, and the electronic address of said persons.

6. An arrangement according to claim 1, wherein said instructions, related to an economic transaction, is sent to the central unit, a banking institution or the like.

7. An arrangement according to claim 1, wherein in that the instructions, sent to the central unit, are related to an agreement between two or more slave units of respective parties.

8. An arrangement according to claim 7, wherein the central unit includes or co-acts with third means, functioning to allow said document and/or said instructions or agreements to be copied and sent to each person or entity that shall sign the document with its instructions or agreements electronically in his/her capacity of an authorised person.

9. An arrangement according to claim 8, wherein when each person sends his/her copy of the document, bearing instructions or agreements and duly signed electronically by said person in his/her capacity of a person authorised in respect of a first party, the central unit is allowed to send a copy of the thus signed document bearing said instructions or agreements to each authorised person of a second party for signing of the document bearing said instructions or agreements electronically.

10. An arrangement according to claim 1, wherein the central unit includes or co-acts with fourth means, for carrying out requisite authority checks in an archive or the like, in which relevant powers of attorney for participating parties are stored.

11. An arrangement according to claim 10, wherein said archive includes a number of organisation identities, such as organisation numbers, current e-mail addresses, company seats, certificates relating to private keys of party-associated persons.

12. An arrangement according to claim 1, wherein the central unit co-acts with or includes fifth means, for the registration of powers of attorney relating to party-associated persons, wherein the arrangement includes the possibility of altering information stored in said register, such as the duration of an appointment, the activation of a blocking function, and/or the insertion of new information.

13. An arrangement according to claim 12, wherein said register includes a number of authority codes.

14. An arrangement according to claim 13, wherein said authority codes are structured to enable the determination of conditions that are tied to a chosen instruction or to a chosen agreement.

15. An arrangement according to claim 13, wherein a first authority code denotes that the authority required exists in a signature from each member of the Board; in that a second authority code denotes that the authority required resides in the joint signing of two or more given persons; in that a third authority code denotes that the authority required resides solely in the signature of the Managing Director (routine business matters); in that a fourth authority code denotes that the authority required resides in a message sent to a board member, such as the Chairman of the Board; and in that a fifth authority code denotes that the authority required is a so-called financial power of attorney.
